(19) United States
(12) Patent Application Publication
(10) Pub. No.: US 2002/0066698 A1
(43) Pub. Date: Jun. 6, 2002

(54) Water filtration system and vessel

(76) Inventor: Michael Scott Brunner, Roswell, GA (US)

Correspondence Address: Douglas H. Yulley Jr., Kimberly-Clark Worldwide, Inc., 401 North Lake Street, Neenah, WI, 54956, US

(21) Appl. No.: 09/729,530

(22) Filed: Dec. 4, 2000

(51) Int. Cl. B01D 29/01; B01D 35/00

(52) U.S. Cl. 210/474

(57) ABSTRACT

A gravity-flow filter system is provided having an upper and lower reservoir separated by a filter; an elongate tube places the filter in fluid communication with the lower reservoir and is selected to have a size such that the natural flow rate of the filter allows the tube to be completely flooded and yet has a flow rate equal to or greater than the average natural flow rate of the filter. The water flowing down the elongate tube into the lower reservoir creates a siphonic drawing force that increases the flow rate of the filter as well as the filter life.

### FIELD OF THE INVENTION

The present invention relates generally to a water filtration system, and more particularly to a water filtration vessel with a flow accelerator feature.

### BACKGROUND OF THE INVENTION

Drinking water in developing countries is often contaminated with biological as well as non-biological pollutants. In this regard, poor sanitation and water disposal practices often allow human and animal waste to contaminate water supplies. Further, poor waste disposal practices or controls often allow industrial pollutants and other contaminants to seep into the ground water and eventually contaminant the drinking water. Contamination of drinking water is further exacerbated by the lack of adequate water supply infrastructure as well as rapid industrialization and population growth.

However, even in developed countries public confidence in the ability of municipal treatment plants to provide safe and/or high quality drinking water has decreased considerably over time. Many municipalities have failed to adequately handle problems associated with high rainfalls, aging water mains, outdated treatment systems and ever increasing demands for water. In this regard, contamination of drinking water can occur as a result of contaminated ground water infiltrating distribution pipes through cracks and fissures. Further, there are additional concerns over the municipalities' ability to deal with the fact that numerous bodies of fresh water, from which municipal water is ultimately drawn, continue to be and/or are increasingly contaminated with various harmful microorganisms and/or industrial waste. Accordingly, there is a heightened interest amongst consumers in increasing the quality of water that is utilized for human consumption. In response to this interest, there are ongoing efforts to develop systems which improve water quality by filtering the water to remove contaminants such as turbidity, chlorine, lead, microorganisms, chemicals and so forth which may affect the color, taste, odor and the overall potability of water.

A variety of filtration systems are currently available that assist in reducing the level of contaminants in water prior to use or ingestion. Many of these systems are referred to as “point-of-use” systems and are designed to filter tap water or other water directly for those who will use or consume the water. Such systems typically include a replaceable filter positioned within some type of housing such as, for example, a bottle, canteen, pitcher, counter-top or faucet-mounted device. Many existing designs utilize a filter that is relatively inexpensive and easy to remove and install. An example of a point-of-use filter is the BRITA filter made by the Clorox Company. The BRITA filter utilizes a pitcher design having an upper reservoir and lid. Positioned below the upper reservoir is a packed filter cartridge extending into the lower reservoir. Water is poured into the upper reservoir and passes through the packed filter cartridge and into the lower reservoir. This particular design is a gravity-flow filter since it is not hooked up to any pressurized water outlets, e.g. a faucet. Eventually, substantially all of the water passes from the upper reservoir to the lower reservoir via the filter cartridge. Water within the lower reservoir can then be poured out from the pitcher by a spout.

One drawback with many point-of-use filter systems is that the filter cartridge often sits within the filtered water and therefore may allow contaminates removed by the filter material to leach back into the lower reservoir. In addition, many gravity-flow filter systems and filter processes are time consuming. In this regard, and particularly with point-of-use filtering systems, consumers prefer a filtering system that more rapidly makes available filtered water without significant delay or inconvenience.

Thus, there remains a need for an inexpensive, reliable and simple water filtration system that provides filtered water in a relatively short timeframe. Further, there exists a need for a water filtration system that provides improved filtering capacity and life. Still further, there exists a need for such a system that limits the possibility of re-contaminating the filtrate.

### SUMMARY OF THE INVENTION

The aforesaid needs are fulfilled and the problems experienced by those skilled in the art overcome by a gravity-flow filter system of the present invention which, in one aspect, comprises a filter system having an upper container and a lower container, a filter in fluid communication with the upper container and an elongate channel placing the lower container in fluid communication with the filter. Thus, water placed in the upper container flows through the filter and into the elongate channel and from the elongate channel into the lower reservoir. The use of the elongate channel to transport filtered liquid from the filter into the lower container creates a siphonic force that helps draw liquid through the filter, thereby increasing the filter's flow rate. In addition, the increased draw force also helps improve the capacity and life of many filters since the increased draw force causes fluid to flow through a higher number of pores, i.e. it causes more pores to wet-out and thereby improves the filter capacity and/or life. The elongate channel has a cross-sectional area selected according to the natural flow rate of the filter; the cross-sectional area of the elongate channel is small enough wherein the liquid flowing from the filter is sufficient to wet-out the elongate channel (i.e. purge the channel of air) and large enough such that, once purged of air, the channel has a flow rate equal to or greater than the average natural flow rate of the filter. Desirably the cross-sectional area of the elongate channel is about the same as or greater than the maximum natural flow rate of the filter. In a particular embodiment, the elongate channel can have an L:Dᵢ ratio of at least 4:1, where L is the length of the channel and Dᵢ the inner diameter of the channel. In a further aspect, the channel desirably has a length in excess of 2.5 cm and still more desirably a length of at least about 10 cm. The elongate channel can comprise either hydrophilic or hydrophobic materials as well as either flexible or substantially rigid materials.

In addition, the filter system can have a flow space beneath the filter wherein liquid exiting the filter is directed towards and into the elongate channel. Desirably, the flow space is substantially co-extensive with that of the filter. In a further aspect, the above components can be contained within a single vessel such as, for example, within a pitcher. In this regard the filter material and flow space can be located within the bottom portion of the upper container and the elongate channel can extend into the lower container. In addition, the vessel can have a spout in fluid communication with the lower container thereby allowing the filtered liquid to be easily poured into another container, e.g. a drinking glass.

### BRIEF DESCRIPTION OF THE DRAWINGS

FIG. 1 is a partially broken-away, perspective view of an embodiment of a filtration system according to the present invention.

FIG. 2 is a cross-sectional side view of the filtration system depicted in FIG. 1 taken at A-A′.

FIG. 3 is an exploded view of a filter system of the present invention comprising a pitcher.

FIG. 4 is a top, partially broken-away view of a filter element suitable for use in the present invention.

FIG. 5 is a cross-sectional side-view of the filter element depicted in FIG. 4 taken at B-B′.

FIG. 6 is a side view of a testing apparatus for determining the natural flow rate of a filter at a constant hydrohead level.

FIG. 6A is a side view of a testing apparatus for determining the flow rate, at a constant hydrohead, of a filter in fluid communication with an elongate tube.

FIG. 7 is a graph depicting flow rate vs. elongate tube inner diameter.

### DESCRIPTION OF THE INVENTION

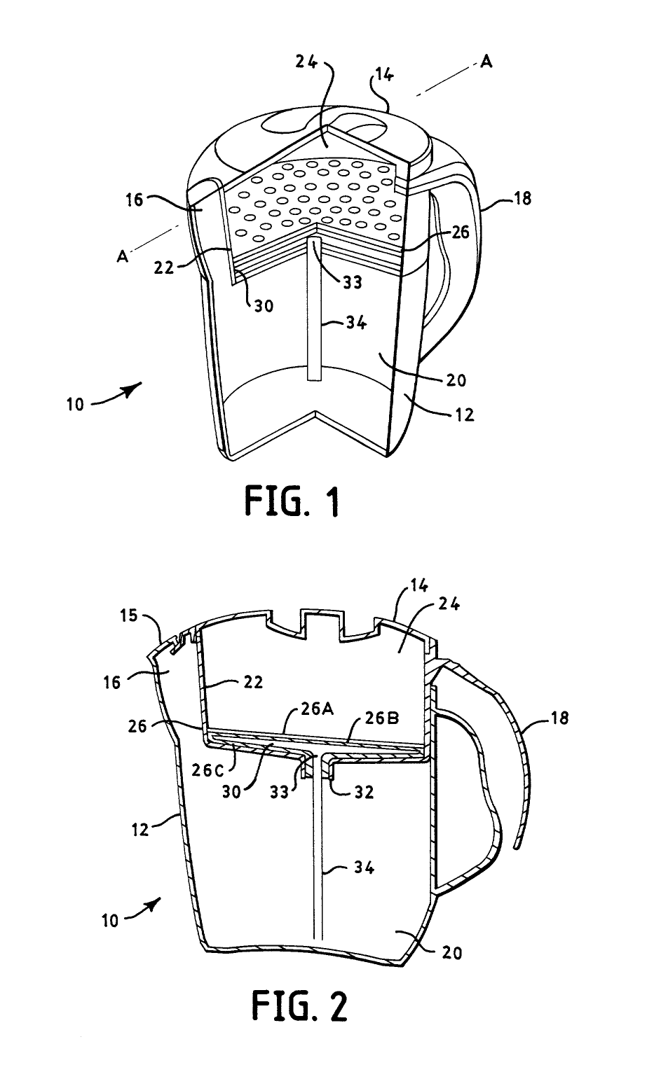

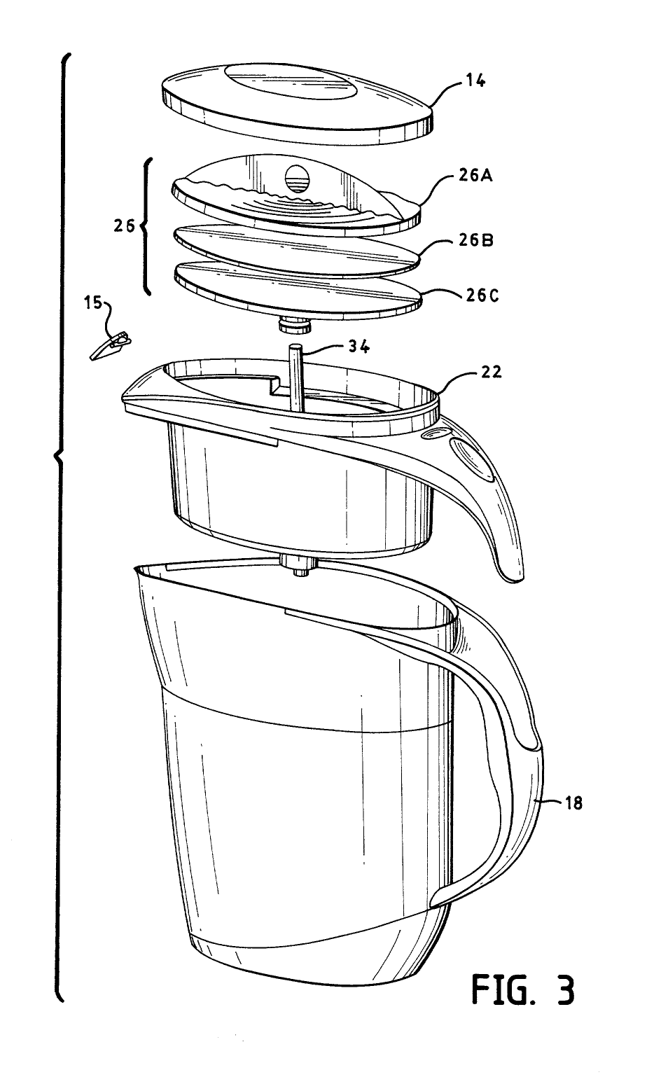

In response to the foregoing problems and difficulties encountered by those of skill in the art, the present invention is directed to a filtration system 10, an exemplary embodiment of which is depicted in FIGS. 1 and 2. Further, FIG. 3 also depicts an exploded view of an exemplary pitcher design incorporating the filter system of the present invention. The filtration system 10 shown therein includes a receptacle or vessel such as a pitcher 12 which may include a first reservoir 24, a filter element 26, an elongate channel 34 and a second reservoir 20. Water is poured into the first reservoir 24 and passes through filter element 26 and into channel 34. From the channel 34 the filtered water then passes into the second reservoir 20. The filtered water can then be poured out of the pitcher 12 when desired through exit opening 16 such as, for example, a spout.

Although the following detailed description will be made primarily in the context of a pitcher, one skilled in the art will appreciate that the concepts of the present invention would also be suitable for use in connection with other types of filtration systems and products, particularly other gravity-flow filtration products including, but not limited to, those in the form of carafes, bottles, water coolers, canisters and so forth. In addition, although the present invention is described in the context of a specific configuration, it will likewise be appreciated that further combinations or alterations of the specific configuration discussed below may be made by one skilled in the art without departing from the spirit and scope of the present invention.

A variety of materials may be utilized for the pitcher 12, including glass, plastics, metals, ceramics and any combination thereof. In selected embodiments, the pitcher 12 may be produced from a plastic such as, for example, polyethylenes, polypropylenes, polystyrenes, polyvinyl chlorides, acrylics, polycarbonates and so forth. In certain of such selected embodiments, at least a portion of the pitcher 12 and/or cover 14 may be produced from a transparent or translucent material such as glass or clear plastics. In addition, the pitcher can be designed so as to form an exit opening such as a spout 16 for easily directing the fluid out the pitcher 12 as desired. The spout 16 can, optionally, have a removable or adjustable closure mechanism 15 such as, for example, a flap or snap on cap. Further, a cover 14 may engage an upper portion of the pitcher 12 and, in selected embodiments, may engage the pitcher 12 so as to form a watertight seal. The cover 14 can be removably-engaged with the pitcher 12 or, optionally, may be fixedly-attached to the pitcher and have a fill opening (not shown) therein. In this regard, the fill opening may be adapted to sealingly engage a fluid source such as, for example, a faucet or a sprayer. Desirably, the pitcher 12 also has a handle 18 in order to facilitate pouring filtered water out of the spout 16 as well as generally increasing the ease with which the pitcher 12 is moved or otherwise handled. In this regard, the pitcher 12 is desirably of a size and shape such that the vessel can be easily handled and, in a further aspect, is desirably of a size that allows the vessel to be placed in a household refrigerator.

The pitcher 12 may contain a first reservoir 24, at least partially above the second reservoir 20, for receiving and temporarily housing the unfiltered water. By placing the first reservoir above the second reservoir gravity helps drive the water through the filter element 26. The first reservoir 24 can be made as a permanent portion of the pitcher 12 or can be adapted to be a removable insert. The first reservoir 24 can be defined by containment wall 22 within the pitcher 12 such that the first and second reservoirs 24, 20 are in fluid communication only via the filter element 26 and the elongate channel 34. In a particular embodiment, the filter element 26 and fluid space 30 can be located within the bottom portion of the first reservoir 24. In addition, the containment wall 22 can be configured to have an outlet opening 32 that is in fluid communication with, and more desirably directly connected to, the elongate channel 34. The containment wall 22 can comprise materials similar to and/or the same as those discussed above with regard to the pitcher 12.

The filter element 26 can comprise one or more materials suitable for use in point-of-use filtration applications and thus a wide variety of filters may be utilized in conjunction with the present invention. As examples, the filter material may comprise a microfiber material or a membrane such as, for example, a charge-modified nonwoven web. Membranes and microfiber layers comprise materials having small average pore sizes which provides excellent mechanical entrapment properties and the ability to remove contaminants such as sediment, turbidity, rust particles, microbiological cysts (e.g. cryptosporidium and giardia) and so forth. In addition, electrostatically charging microfiber filter media also enables filter media to entrap bacteria and other micro-biologicals. Additionally and/or alternately, the filter media may comprise materials containing or coated with one or more active agents such as, for example, block activated carbon, granular activated carbon, dissolvable disinfectants, zeolites, ion-exchange resins and so forth. In this regard, activated carbon composite materials are useful in removing various chemicals such as, for example, hydrocarbons, herbicides, pesticides, chlorine, as well as numerous other contaminants whereas zeolites and ion-exchange resins are useful in removing various metals and ionic matter such as, for example, lead, copper and so forth. In view of the foregoing, laminates of one or more filter materials can be utilized in order to provide a filter material having excellent filtration properties for a wide range of common but dissimilar contaminants. As but one example, the filter can comprise upper and lower microfiber fabrics, such as charge modified glass fiber webs, and one or more central layers of a composite material containing activated carbon.

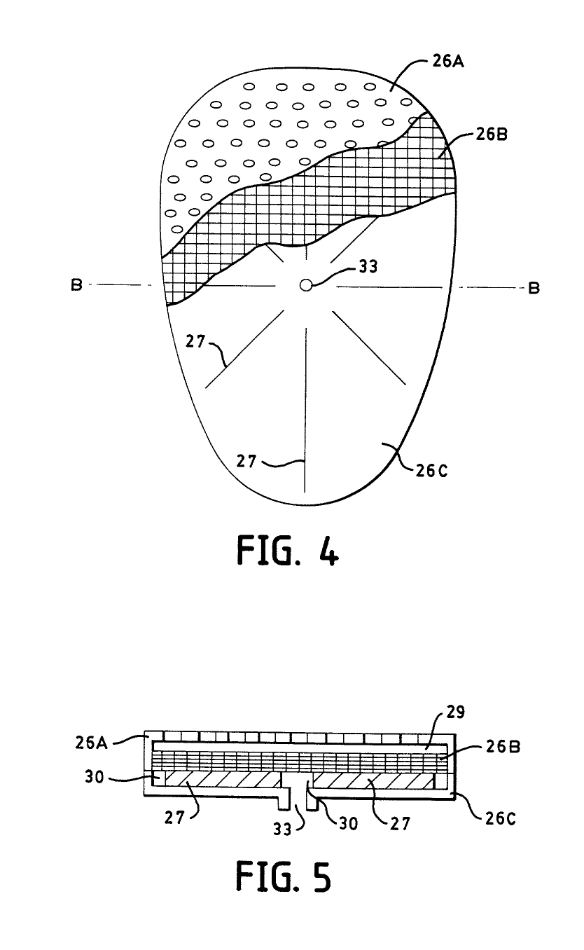

As an example and in reference to FIGS. 4 and 5, a filter element 26 can comprise a first support layer 26A, filter media 26B and a second support layer 26C. The first support layer 26A desirably comprises a perforated plastic capable of evenly distributing liquid across the filter media 26B. While filter media 26B is shown as a single layer it will be appreciated that the filter media can comprise multiple layers such as, for example, the multilayer laminates discussed herein above. The filter element 26 can be designed to be inserted within the pitcher 12 and form a watertight seal with containment wall 22 such that only water passing through the filter element 26 enters the elongate channel 34.

An inherent limitation of filters employing chemical and/or mechanical entrapment is that they have a limited life. Therefore, it is desirable that the filter material and/or a filter element be configured so as to be capable of being easily inserted and removed from the filter system. A handle can, optionally, be provided upon the filter element to aid removal and insertion of the same. Desirably, once the filter has reached the end of its useful life, the filter element 26 may be replaced with a new filter element 26 or may be reused upon reconditioning to restore its filtering properties. In a further aspect, the filter element can be designed such that the filter media can itself be removed from the filter element such that the filter element, having a new or reconditioned filter media inserted therein, can be re-used in the pitcher. The filter element 26 desirably forms a water-tight seal with the containment wall 22 so as not to allow unfiltered water to flow into the channel 34 and the second reservoir 20. To accomplish this, the filter element 26 can be attached to the containment wall 22 by various mechanisms known in the art such as, for example, by o-rings, screw assemblies, as well as friction-fit and other watertight seal mechanisms.

The filter element can comprise part of or be located above the containment wall. In reference to FIGS. 1 and 2, the filter element 26 is positioned immediately above the containment wall 22. The filter system and/or filter element is desirably configured to provide a flow space 30 under filter media 26B in order to enhance the flow of liquid out of and away from the filter media 26B and into the elongate channel 34. As an example, the second support layer 26C can contain a series of supporting ridges 27 that position the filter media 26B above the second support layer 26C thereby forming a flow space 30. The supporting ridges 27 also help direct the water towards the opening 33 within the second support layer 26C. Positioning the filter element a set distance above the containment wall can alternatively, form the flow space. In this regard, the ridges can be provided upon and extend downwardly from the bottom portion of the second support layer and/or can be provided upon and extend upwards from the containment wall. Desirably, the flow space 30 extends under substantially the entire portion of the filter media 26B and also is of a size such that water exiting the filter media 26B flows substantially unrestricted towards and into the outlet opening 33. In addition, the flow space is desirably pitched such that the water flows towards the corresponding outlet opening. With most home filtration systems, the flow space 30 should have a height of at least about 0.5 mm and more desirably has a height of between 0.1 cm and about 15 cm. In addition, desirably there is a similar gap or flow space 29 between the first support layer 26A and filter media 26B as well.

Liquid entering the flow space 30 can then enter the outlet opening 33 and elongate channel 34. With regard to FIGS. 2 and 5, the outlet opening 33 within the second supporting layer 26C is desirably placed above and, optionally, extends into the outlet opening 32 within containment wall 22. Elongate channel 34, when placed in outlet opening 32, is in fluid communication with the outlet opening 33. Water flowing through opening 33 into elongate channel 34 exits into the second reservoir 20. The first reservoir 24 is thereby placed in fluid communication with the second reservoir 20 via filter element 26, flow space 30 and elongate channel 34. The outlet openings 32 and/or 33 can have varied sizes and shapes. In addition, the outlet openings can, optionally, include a mesh screen or other material that is capable of collecting any particulate material, such as activated carbon, that may escape from the filter media. The outlet opening 33 desirably has a cross-sectional area about the same as or larger than that of the accelerator tube or channel 34. Elongate channel 34 can extend beneath the outlet opening 33 and into the second reservoir 20. The cross-sectional area of the elongate channel 34 will be selected based upon the natural flow rate of the filter and the composition of the tube as discussed herein.

As used herein the term “natural flow rate” means the flow rate of liquid through the filter media without the application of siphonic or other applied pressure with the exception of that resulting from gravity and the liquid above the filter. Thus, the natural flow rate is calculated without the elongate channel connected to the system. It will be appreciated that the actual flow rate of the filter material will vary and reflects the available pressure (such as that created by the water overhead) and the nature of the filter material (e.g. average pore size, percent openness, composition, etc.). In addition, the term “average natural flow rate” means the mean flow rate of the filter in the filter system (without the elongate channel within the system) with the hydrohead of the filter system varied between 0—maximum; the average natural flow rate can be readily calculated by filling the upper reservoir to capacity and allowing the filter system to empty the reservoir, e.g. filter the liquid. The volume of the upper reservoir divided by the time it takes to filter the liquid therein yields the average natural flow rate of the filter. Additionally, the term “maximum natural flow rate” means the highest actual flow rate of the filter within the filter system; with gravity flow filters the highest flow rates are typically achieved after the filter is wetted out and when the unfiltered water in the upper reservoir is at or near the maximum height. Considering these factors, the channel 34 is selected to have an interior cross-sectional area that is not so small so as to impede the average natural flow rate of the filter and yet which is small enough that it can be entirely wet out and be purged of air when water is fed through the filter system. As used herein the term “wet out” or “wetting out” with respect to the elongate channel means flooding and/or filling the channel such that it is substantially devoid of air. Once the channel is completely wet out, water flowing down the channel 34 into the second reservoir 20 creates a vacuum, e.g. a siphonic force, thereby drawing water through the filter. The additional siphonic force increases the flow rate of the filter. In this regard it has been found that the increased drawing force can cause more pores within the filter material to wet-out and in turn can increase the filter capacity and extend the life of the filter. Additionally, use of the channel or tube to create the additional siphonic force to drive the water through the filter allows use of a filter with a smaller average pore size while maintaining the same flow rate (compared to filter systems without the elongated channel). In order to maximize the initial flow rate of the entire filter system, the elongate channel desirably has a cross-sectional area which provides a flow rate substantially the same as or greater than the maximum natural flow rate of the filter.

The elongate channel 34 has a length of at least about 2.5 cm and desirably has a length of at least about 5 cm and, still more desirably, a length of at least about 10 cm. In a preferred embodiment, the elongate channel 34 extends substantially into the lower reservoir 20. As an example, the elongate channel 34 desirably extends into and has a length at least 50% of the height of the lower reservoir 20. However, the end of the elongate channel within the lower reservoir is desirably greater than 0.1 cm above the bottom of the lower reservoir and still more desirably at least about 1 cm above the bottom of the lower reservoir. While various configurations are suitable the channel 34 desirably comprises a substantially tubular shape such as a pipe. In a further aspect of the present invention, the elongate channel desirably has a L:Dᵢ ratio of at least 4 (where Dᵢ is the inner diameter of the channel and L is the length of the channel) and, more desirably, has a L:Dᵢ ratio of at least about 10:1 and, still more desirably has a L:Dᵢ ratio of at least about 25:1. As a particular example, for a filter having a natural flow rate of about 180 milliliters/minute, the elongate channel desirably comprises a hydrophilic tube having a cross-sectional area of about 0.6 cm² to about 1.3 cm². In addition, it will be appreciated that similar results can be achieved by utilizing a plurality of elongate channels where the diameters and flow rates of the channels are selected wherein each of the channels can wet out and that the collective flow rate of the channels do not limit the natural flow rate of the filter.

Elongate channel 34 can comprise substantially rigid materials similar to those discussed herein above with regard to the pitcher 12. In addition, elongate channel 34 can comprise flexible materials such as, for example, rubber, pliable plastic tubing (e.g. polyethylene or vinyl), and so forth. Desirably, the channel 34 comprises a hydrophilic material such as, for example, stainless steel or polycarbonates. In this regard, it is believed that use of a hydrophilic material helps the tube initially wet out and purge the same of air. The tube 34 can be permanently fixed to the outlet opening 32 and/or 33 or can be releasably-engaged to the same. Desirably, the channel 34 and outlet openings 32 and 33 are configured to allow the tube 34 to be readily attached and removed from the outlet opening 33. As examples, the elongate channel can be attached to the outlet opening by various mechanisms known in the art such as, for example, snap-fit, screw assembly, o-rings and friction fit (e.g. where the outlet opening has a tapered interior cross-section), and so forth. Further, where the channel or tube comprises a highly flexible and/or elastic material, such as rubber, the tube can simply be fitted over the exterior of the outlet opening that extends beneath the upper reservoir.

### EXAMPLE

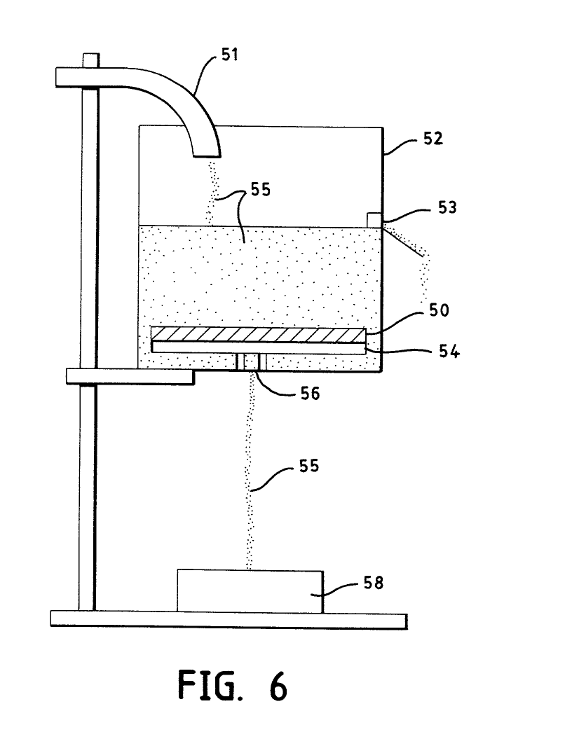

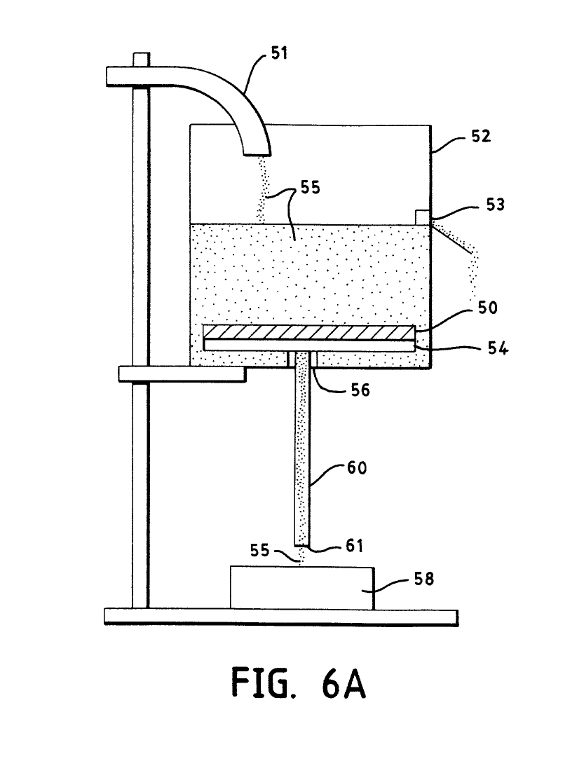

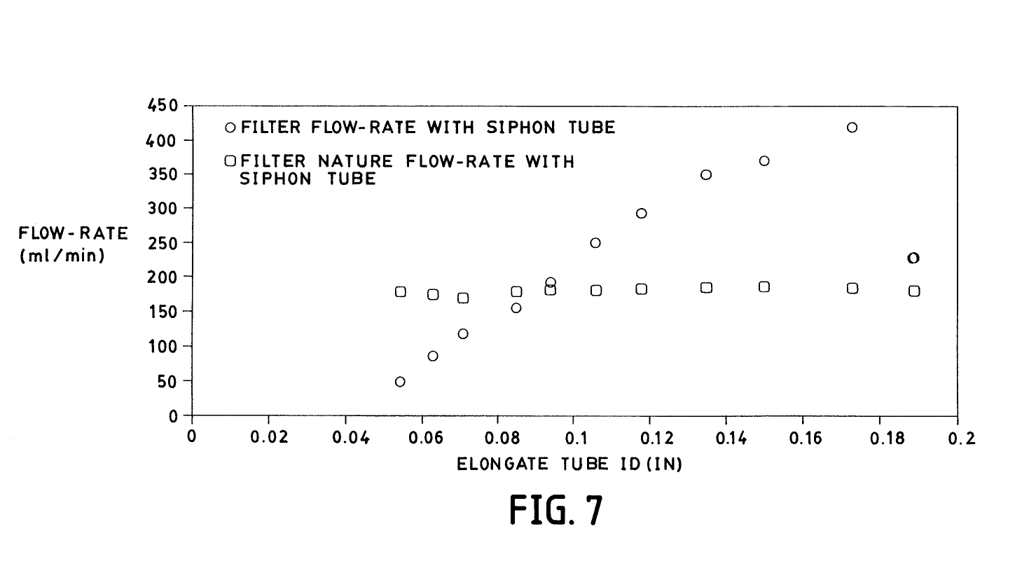

The flow rate of a filter material was evaluated in systems similar to those depicted in FIGS. 6 and 6A. A filter material 50 having a cross-sectional area of 11 square inches (71 cm²) was supported approximately 0.127 cm above the bottom of a container 52 thereby creating a flow space 54. The bottom of the container 52 had a centrally located circular outlet opening 56. Water 55 was maintained at a constant height of about 5.7 cm over the filter material 50. Water 55 was directed into container 52 from a water feed tube 51 and water 55 above the desired hydrohead exited container 52 through a reservoir overflow outlet 53. Using the system depicted in FIG. 6, the water 55 flowing through the filter 50 and out of the outlet opening 56 was directed into a flow-meter 58 and registered to determine the natural flow rate of the filter system at the aforesaid hydrohead (the natural flow rate being calculated without the elongate tubing 60 as depicted in FIG. 6). Thereafter, circular stainless steel tubing 60 of varied diameters were placed in fluid communication with the outlet opening 56 thereby creating the system depicted in FIG. 6A. The length of the different tubing 60 was held consistent at 14.6 cm. The water flowing through the filter 50 and out of the tube outlet 61 was directed into a flow-meter 58 and registered to determine the actual flow rate of the filter system. The respective flow rates of the two filter systems can be compared by reviewing the graph depicted in FIG. 7.

Review of the above data indicates that the flow rate of the filter system was improved by employing an elongate fluid channel. However, the improvement in flow rate of the filter system has a fixed operating range that is defined by the relationship between the natural flow rate of the filter and the cross-section of the tubing. Once the cross-sectional area of the tubing reached a minimum value the flow rate of the filter system began to decrease since the flow rate of the tube was less than the natural flow rate of the filter. In addition, once the cross-sectional area of the tubing reaches a maximum the flow rate of the filter system began to decrease since the natural flow rate of the filter was insufficient to wet out the tubing and allow for the creation of the siphonic drawing force. Thus, by providing an elongated fluid channel having the appropriate cross-sectional area, relative to the natural flow rate of the filter material, the overall flow rate of the filter can be improved.

While the invention has been described in detail with respect to specific embodiments thereof, it will be appreciated that those skilled in the art, upon attaining an understanding of the foregoing, may readily conceive of alterations to and variations of the embodiments disclosed herein. Such alterations and variations are believed to fall within the scope and spirit of the present invention and the appended claims.

What is claimed is:

1. A filter system comprising:
an upper container and a lower container;
a filter in fluid communication with the upper container; and
at least one elongate channel placing said lower container in fluid communication with said filter.

2. The filter system of claim 1 wherein said elongate channel has a L:Dᵢ ratio of at least 4:1.

3. The filter system of claim 2 wherein the elongate channel has a length in excess of about 2.5 cm.

4. The filter system of claim 2 wherein said elongate channel has a length in excess of about 5 cm.

5. The filter system of claim 4 wherein said elongate channel has a substantially circular cross-sectional configuration and has an inner diameter between about 0.25 cm and about 0.5 cm.

6. The filter system of claim 4 wherein a flow space places said filter in fluid communication with said elongate channel

7. The filter system of claim 1 wherein said elongate channel has a length in excess of about 10 cm.

8. The filter system of claim 7 wherein said elongate channel has an L:Dᵢ ratio of at least 10:1.

9. The filter system of claim 1 wherein said elongate channel has an L:Dᵢ ratio of at least 25:1.

10. The filter system of claim 1 wherein said filter has an average natural flow rate and wherein said elongate channel has a flow rate substantially the same as or larger than the average natural flow rate of said filter and further wherein said average natural flow rate of said filter wets out said elongate channel.

11. The filter system of claim 10 wherein said elongate channel has a length of at least about 5 cm and an L:Dᵢ ratio of at least 10:1 and further wherein said filter and said elongate channel are separated by a flow space of at least 0.1 cm.

12. The filter system of claim 1 wherein said filter has a maximum natural flow rate and wherein said elongate channel has a flow rate substantially the same as or larger than the maximum natural flow rate of said filter and further wherein said maximum natural flow rate of said filter wets out said elongate channel.

13. The filter system of claim 10 wherein said elongate channel is has a length of at least about 5 cm and an L:Dᵢ ratio of at least 4:1 and further wherein said filter and said elongate channel are separated by a flow space of at least 0.1 cm.

14. The filter system of claim 12 wherein said elongate channel has a length of at least 2.5 cm and a cross-sectional area and length selected, relative to the natural flow rate of the filter, to create a siphonic drawing force when liquid is flowing through the filter and elongate channel into the lower container.

15. The filter system of claim 14 wherein said filter and said elongate channel are separated by a flow space of at least 1 mm.

16. The filter system of claim 15 wherein said filter is located within said upper container and is positioned at least 1 mm above the bottom of said upper container thereby defining a flow space.

17. The filter system of claim 16 wherein said filter comprises a flat filter laminate.

18. The filter system of claim 16 wherein said filter further comprises upper and lower filter support members and wherein said filter is detachably-engaged with said upper container.

19. The filter system of claim 18 wherein said elongate channel comprises a tube extending into the lower container and wherein said tube has a length at least equal to half of the height of the lower container.

20. The filter system of claim 19 wherein said elongate channel is releasably-engaged with said upper container.

21. The filter system of claim 14 wherein said elongate channel comprises a hydrophilic tube.

22. The filter system of any of claims 14 wherein said filter and said lower container are in fluid communication with one another via a single elongate channel.

23. The filter system of claim 14 wherein said filter and said lower container are in fluid communication with one another via at least two elongate channels.

24. The filter system of claim 14 wherein said upper and lower containers, said filter and said elongate channel are leach located within and form a single article selected from the group consisting of pitchers, bottles, carafes and canisters.

25. The filter system of claim 14 wherein said upper and lower containers, said filter and said elongate channel are leach located within a pitcher and further wherein said pitcher has a handle and an exit spout in fluid communication with said lower container.
